(19) United States
(12) Patent Application Publication
(10) Pub. No.: US 2012/0308357 A1
(43) Pub. Date: Dec. 6, 2012

(54) STACKABLE CONTAINER

(75) Inventors: Bradley Gordon Friesen, Vancouver (CA); Alexander Trampolski, Eastvale, CA (US)

(73) Assignee: Bottlecap Holdings Ltd.

(21) Appl. No.: 13/467,902

(22) Filed: May 9, 2012

Related U.S. Application Data
(63) Continuation-in-part of application No. 29/406,229, filed on Nov. 10, 2011.

(30) Foreign Application Priority Data
May 11, 2011 (CA) 140596

(51) Int. Cl. B65D 21/036; B65G 57/22

(52) U.S. Cl. 414/802; 215/10

(57) ABSTRACT

The present disclosure is directed at a stackable container including a body with an upper section having a plurality of upper wall panels, a lower section having a plurality of lower wall panels, a middle section positioned between the upper and lower section having a plurality of middle wall panels and a bottom surface connected to the lower section. A container neck is connected to the upper section of the body. The container also includes a cap removably engaged with the neck. To provide stability when the containers are stacked in diagonal orientation, the bottom section includes a recess and the recess and the cap are configured such that there is interconnection between the cap of one container and the recess of a diagonally adjacent container.

### CROSS REFERENCE TO RELATED APPLICATIONS

The present application is a continuation-in-part of U.S. Design Application No. 29/406,229, filed Nov. 10, 2011, which claims priority to Canadian Industrial Design Application No. 140596, filed May 11, 2011. U.S. Design Application No. 29/406,229 and Canadian Industrial Design Application No. 140596 are incorporated herein by reference.

### TECHNICAL FIELD

The present disclosure is directed at a stackable container. More specifically, the disclosure is directed to a stackable beverage container.

### BACKGROUND

There is an increasing demand for beverage containers that can be stacked in a space efficient and eye catching way on grocery store shelves and behind bars at nightclubs, pubs and restaurants.

### SUMMARY

According to a first aspect, there is provided stackable container including a body and a neck. The body includes an upper section having a plurality of upper wall panels, a lower section having a plurality of lower wall panels, a middle section positioned between the upper and lower section having a plurality of middle wall panels, and a bottom surface connected to the lower section. The bottom surface has a recess therein and a cap is removably engaged with the neck. The recess and the cap are configured such that there is interconnection between the cap of one container and the recess of an adjacent container when the containers are stacked.

The length of the container body may be the same as the width of the container body. The cap may include a cap body with a raised portion on a top surface thereof, and the recess may include a flange presenting an internal ridge around the recess wall, the raised portion of the cap is dimensioned to nest within the recess of an adjacent container and abut the flange therein. The raised portion of the cap may be of smaller cross-section than the cap body.

The middle section of the container body may include four quadrilateral wall panels and four hexagonal wall panels, with the quadrilateral wall panels and the hexagonal wall panels alternating around the middle section. The quadrilateral wall panels may be square wall panels. The upper section of the container body may include four upper hexagonal wall panels. The lower section of the container body may include four lower hexagonal wall panels. The upper section may further include four upper shoulders positioned between the four upper hexagonal wall panels and the lower section may further include four lower shoulders positioned between the four lower hexagonal wall panels. The upper, lower, or upper and lower shoulders may be triangular shaped.

According to another aspect, there is provided a method of diagonally stacking a plurality of the stackable containers such that the axis of each container is on the diagonal. The method includes positioning a first row of containers in diagonal orientation with one of the upper wall panels of one container contacting one of the lower wall panels of an adjacent container, positioning a second row of containers in diagonal orientation on top of the first row of containers with one of the lower wall panels of each container in the second row of containers overlying one of the upper wall panels of each adjacent container in the first row of containers, and interconnecting the cap of containers in the first row of containers with the recess of diagonally adjacent containers in the second row of containers.

### BRIEF DESCRIPTION OF THE DRAWINGS

In the accompanying drawings, which illustrate one or more exemplary embodiments:

FIG. 1 is a front elevation view of a container of the prior art.

FIG. 2 is a front elevation view of a plurality of prior art containers of FIG. 1 stacked in diagonal orientation.

FIG. 3 is a front elevation view of a container according to an embodiment.

FIG. 4A is a front elevation view of the container of FIG. 3 with a cap engaging a neck of the container.

FIG. 4B is a front elevation view of the cap of FIG. 4A.

FIG. 5 is a bottom plan view of the container of FIG. 3.

FIG. 6A is a front elevation view of a plurality of containers of FIG. 3 stacked in diagonal orientation.

FIG. 6B is a close up elevation view of the plurality of stacked containers of FIG. 6A.

FIG. 7 is a front elevation view of a container according to another embodiment.

### DETAILED DESCRIPTION

Directional terms such as “top”, “bottom”, “upwards”, “downwards”, “vertically” and “laterally” are used in the following description for the purpose of providing relative reference only, and are not intended to suggest any limitations on how any article is to be positioned during use, or to be mounted in an assembly or relative to an environment.

Containers, such as beverage containers, are found on grocery store shelves and behind bars in restaurants, pubs, nightclubs and the like. In this competitive market, a beverage container that can be stacked in an eye-catching, yet space saving manner may have many benefits. Typically, beverage bottles which contain water, soft beverage, and the like, are stacked side by side, but are not designed to be stack as a wall of containers one on top of the other in a stable manner.

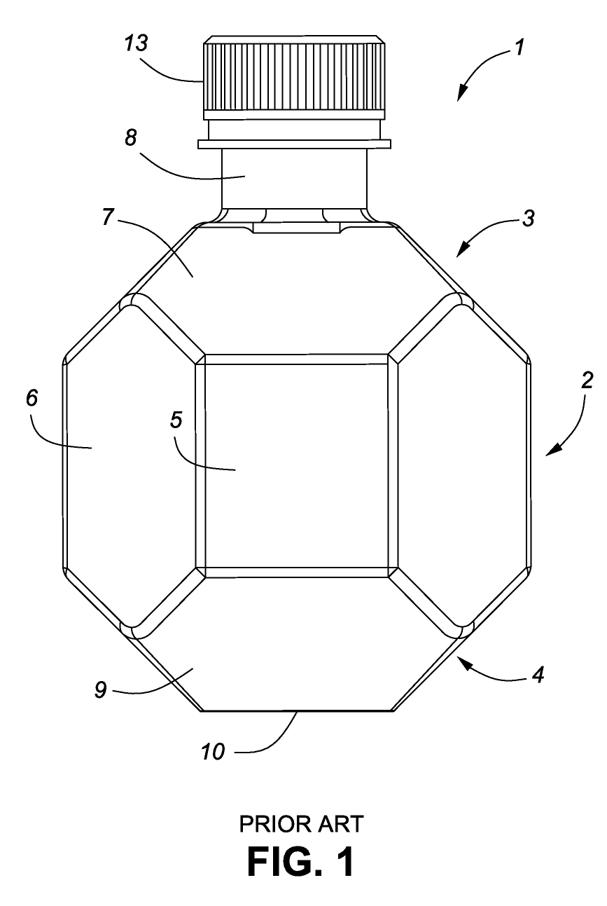

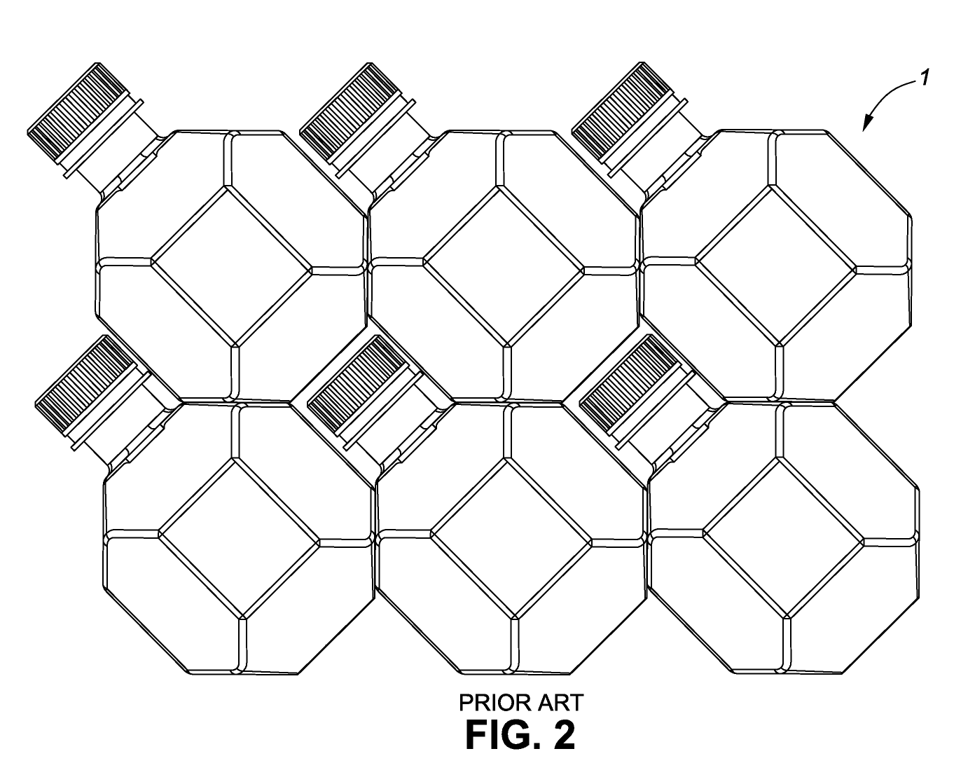

Referring to FIG. 1, there is shown a prior art container 1 having a number of flat surfaces such that the container can be stacked one on top of the other. More specifically, the container 1 is of generally spherical shape with a middle section 2 an upper section 3 and a lower section 4. The middle section 2 is made up of four quadrilateral wall panels 5 and four hexagonal wall panels 6 with the quadrilateral wall panels 5 and the hexagonal wall panels 6 alternating around the middle section 2. The upper section 3 is made up of four hexagonal wall panels 7 which meet at a container neck 8. A cap 13 is received by the container neck 8. The lower section 4 is made up of four hexagonal wall panels 9 which meet at a bottom surface 10. The prior art containers 1 can be stacked in a diagonal orientation as shown in FIG. 2, however, the stacked wall becomes unstable at heights of about four containers high or more as the containers are merely stacked one on top of the other and there is no interconnection between adjacent containers. By diagonal orientation, it is meant that the containers 1 are stacked with the axis of the container on the diagonal rather than horizontal or vertical. In other words, a centre line passing through the container neck 13 and bottom surface 10 of the stacked containers 1 is diagonally orientated.

The embodiments described herein are directed at a container 100 for beverages or other liquids, gels or powders. In particular, the following embodiments are for a container 100 that is stackable one on top of the other in an interconnecting relationship.

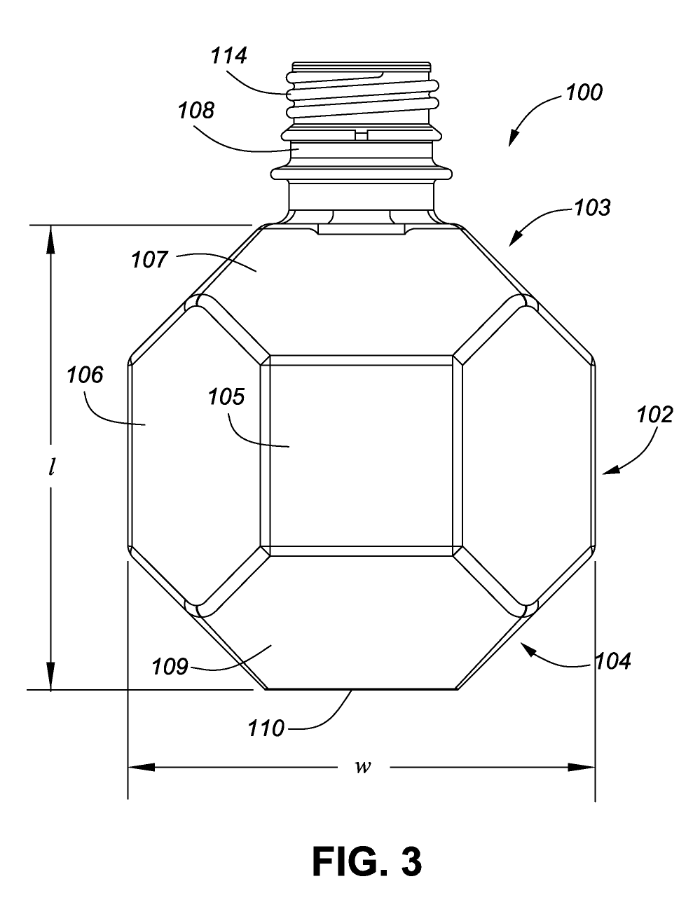

Referring now to FIG. 3, there is shown an embodiment of the container 100. The container 100 includes a hollow body of generally spherical shape and a neck 108. The body has a middle section 102 an upper section 103, a lower section 104 and a bottom surface 110. The middle section 102 is made up of four square wall panels 105 and four hexagonal wall panels 106 with the square wall panels 105 and the hexagonal wall panels 106 alternating around the middle section 102. The upper section 103 is made up of four upper hexagonal wall panels 107 which adjoin the container neck 108. The lower section 104 is made up of four lower hexagonal wall panels 109 which adjoin the bottom surface 110. The length (1) of the container body from the bottom surface 110 to the container neck 108 is the same as the width (w) of the container as shown in FIG. 3. By width of the container (w) it is meant the width from one of the square wall panels 105 to an opposite square wall panel 105 or from one of the hexagonal wall panels 106 to an opposite hexagonal wall panel 106. Therefore in one embodiment the ratio 1:w is 1:1.

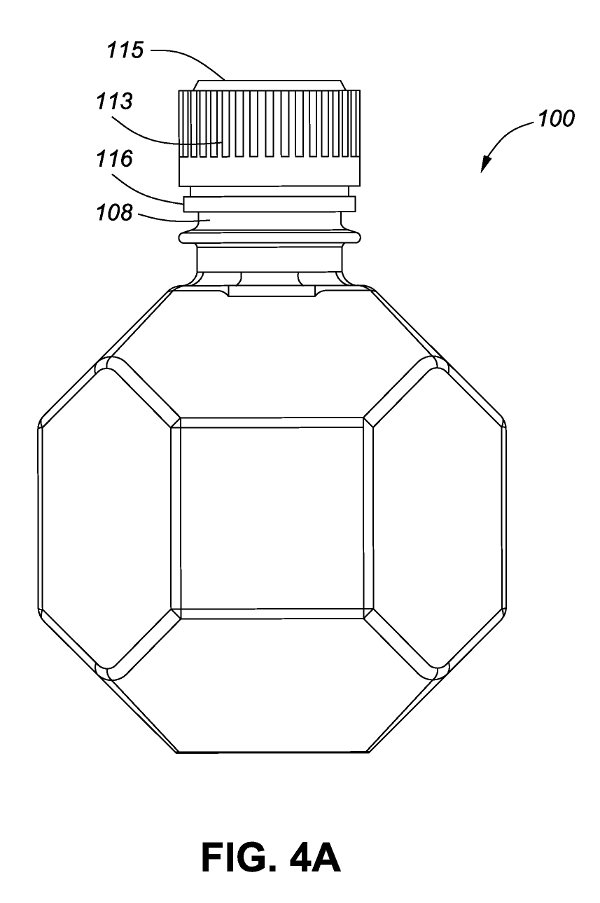

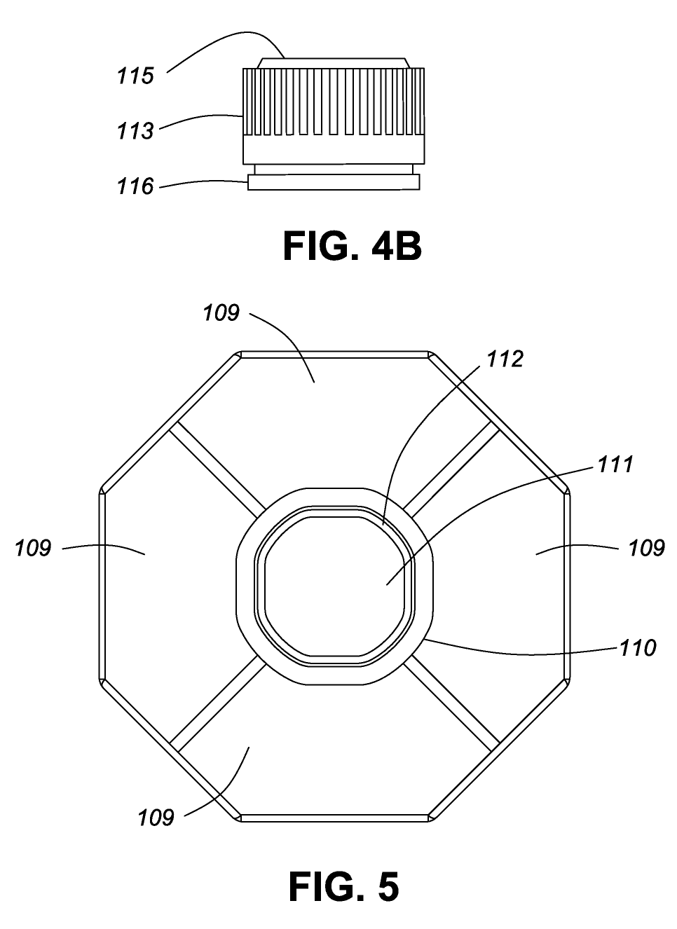

The container neck 108 matingly engages a cap 113 as shown in FIG. 4A. In the embodiment shown in FIG. 3, the container neck 108 has a screw thread 114 and the cap 113 received by the screw thread 114 is a screw type cap, however in alternative embodiments (not shown) the cap 113 may snap fit onto the container neck 108 or matingly engage with the container neck 108 in any other way.

Referring to FIGS. 4A and 4B there is shown an embodiment of the cap 113. The body of the cap 113 is connected to a security ring 116. Twisting of the cap breaks the connection between the cap 113 and the security ring 116. This provides a visual indication that the connection has been broken and the container opened or tampered with. The cap 113 has a raised portion 115 on its top surface. The raised portion 115 has sloped side walls and a flat top surface and is of narrower cross-section than the cross-section of the body of the cap 113.

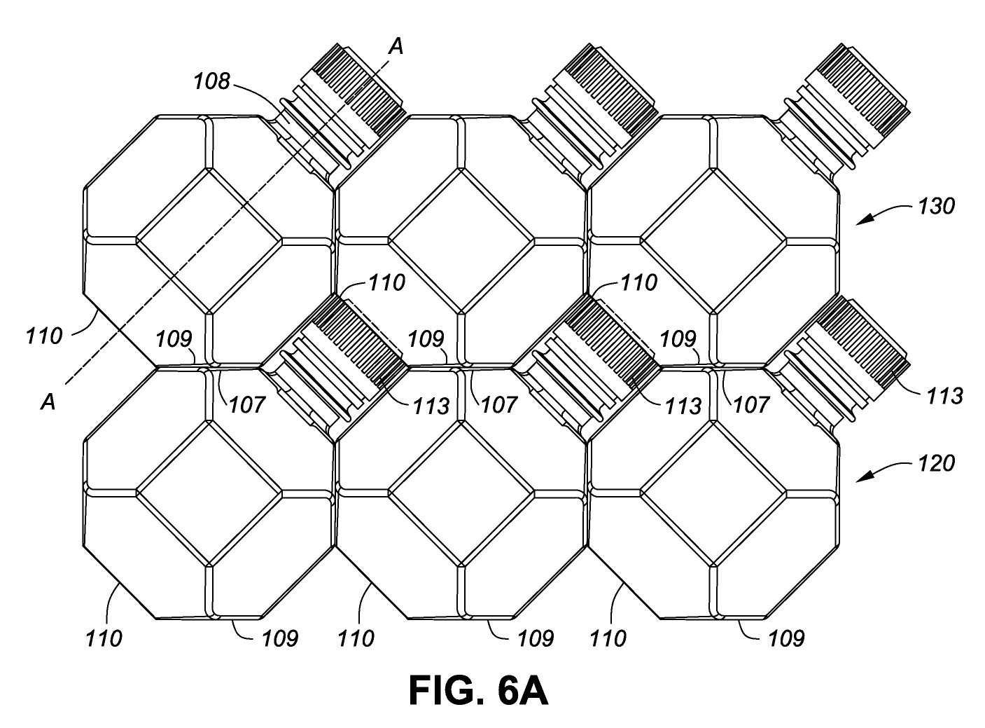

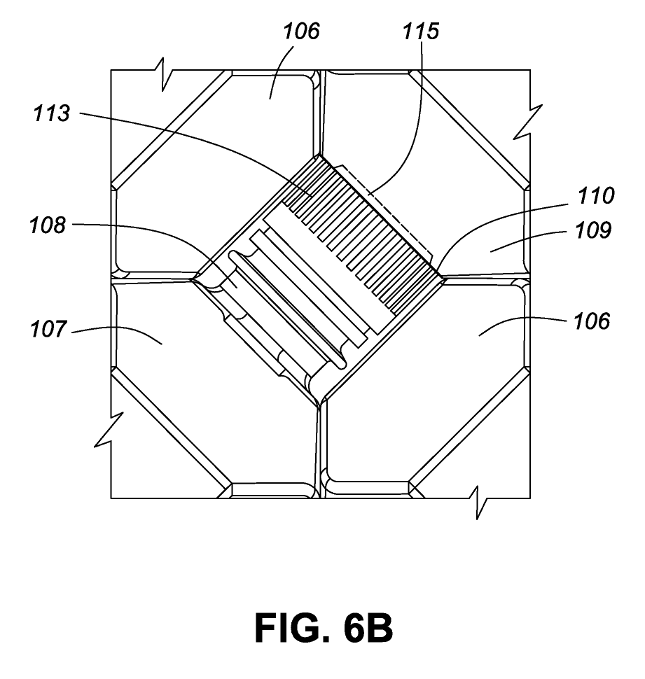

As shown in FIG. 5, the bottom surface 110 of the container includes a recess 111 which has a flange 112 presenting an internal ridge around the recess wall. When the containers 100 are stacked as shown in FIGS. 6A and 6B, the raised portion 115 of the cap is dimensioned to nest within the recess 111 of an adjacent stacked container 100 and abut against the flange 112 therein. In alternative embodiments (not shown) the cap 113 and recess 111 may differ from that shown in FIGS. 4-6, provided the cap and recess are configured such that the cap of one container interconnects with the recess of an adjacent stacked container.

In FIG. 6A and 6B, the containers 100 are stacked one on top of the other in an interconnecting relationship with the containers 100 positioned on their side in diagonal orientation. By diagonal orientation, it is meant that the containers 100 are stacked with the axis of each container on the diagonal rather than horizontal or vertical. In other words, a centre line A-A passing through the container neck 108 and bottom surface 110 of the stacked containers 100 is diagonally orientated as shown in FIG. 6A. In the stacked structure of FIG. 6A, a first row of containers 120 each have one lower hexagonal wall panel 109 adjacent the surface on which the containers are stacked. A second row of containers 130 each have one lower hexagonal wall panel 109 overlying one upper hexagonal wall panel 107 of the first row of containers 120. Stability of the stacked structure is achieved as a result of two structural features of the stacked containers 100 which are not found in the stacked containers 1 of the prior art shown in FIG. 2. The first structural feature is the interconnection of the caps 113 of containers in the first row 120 with the recesses in the bottom surface 110 of diagonally adjacent containers of the second row 130. The second structural feature is the true alignment of the diagonally orientated containers 100 as a result of the ratio of 1:w being 1:1. The stacked structure is therefore diagonally aligned as well as vertically and horizontally aligned. The additional stability provided by these structural features allows the structure to be stacked to about 10 containers high or more.

In the prior art containers 1 shown in FIG. 1, the length of the container 1 from the bottom surface 10 to the container neck 8 is longer than the width of the container. This means that when the containers 1 are stacked in diagonal orientation as shown in FIG. 2, the containers are not diagonally aligned and the upper and lower hexagonal wall panels 7, 9 of adjacent containers in the same row are not flush with each other but overlap instead. Furthermore, there is no interconnection between the caps 13 and the bottom surface 10 of diagonally adjacent containers. The stacked structure of containers 1 of the prior art therefore lacks the stability of the stacked structure of the containers 100 of the embodiments described herein and the maximum height of the prior art diagonally stacked structure is about 4 containers high.

In alternative embodiments (not shown) the containers 100 may be stacked in vertical or horizontal orientation and stability of the stacked structure is provided by the interconnecting cap 113 and recess 111 of adjacent containers 100.

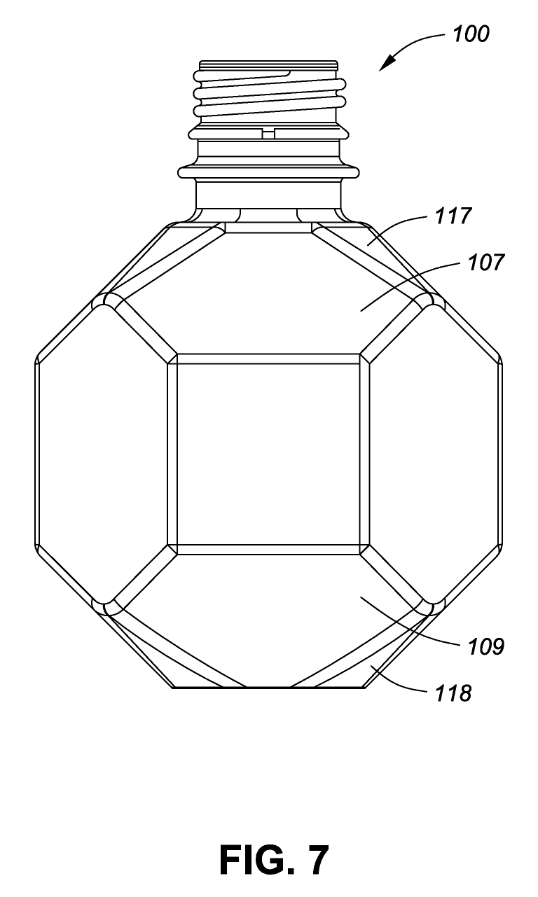

Referring to FIG. 7, there is shown another embodiment of the container 100. In this embodiment, four shoulders 117 are positioned between the four upper hexagonal wall panels 107 and four shoulders 118 are positioned between the four lower hexagonal wall panels 109. The shoulders 116, 117 may be of a general triangular shape.

The containers 100 may be made of a mouldable plastic material, such as polyethylene terephthalate (PET), polycarbonates and the like. The cap 113 may also be made of a plastic material such as polypropylene, polyethylene, high-density polyethylene (HDPE) or the like.

While particular embodiments have been described in the foregoing, it is to be understood that other embodiments are possible and are intended to be included herein. For example, while the foregoing embodiments describe containers 100 with hexagonal wall panels 106, 107, 109 and square wall panels 105, other shapes may be utilized provided there are a plurality of flat surfaces allowing the containers 100 to be stably stacked in a diagonal orientation. It will be clear to any person skilled in the art that modifications of and adjustments to the foregoing embodiments, not shown, are possible.

1. A stackable container comprising:
a body comprising:
(a) an upper section comprising a plurality of upper wall panels,
(b) a lower section comprising a plurality of lower wall panels,
(c) a middle section positioned between the upper and lower section, the middle section comprising a plurality of middle wall panels,
(d) a bottom surface connected to the lower section, the bottom surface having a recess therein,
a neck connected to the upper section of the body, and
a cap removably engaged with the neck,
wherein the recess and the cap are configured such that there is interconnection between the cap of one container and the recess of an adjacent container when the containers are stacked.

2. The stackable container of claim 1, wherein the length of the body is the same as the width of the body.

3. A stackable container comprising:
a body comprising:
(a) an upper section comprising a plurality of upper wall panels,
(b) a lower section comprising a plurality of lower wall panels,
(c) a middle section positioned between the upper and lower section, the middle section comprising a plurality of middle wall panels,
(d) a bottom surface connected to the lower section, the bottom surface having a recess therein,
a neck connected to the upper section of the body, and
a cap removably engaged with the neck,
wherein the recess and the cap are configured such that there is interconnection between the cap of one container and the recess of an adjacent container when the containers are stacked and the length of the body is the same as the width of the body.

4. The stackable container of claim 1, wherein the cap comprises a cap body with a raised portion on a top surface thereof, and the recess comprises a flange presenting an internal ridge around the recess wall, the raised portion of the cap dimensioned to nest within the recess of an adjacent stacked container and abut the flange therein.

5. The stackable container of claim 4, wherein the raised portion of the cap is of narrower cross-section than the cross-section of the cap body.

6. The stackable container of claim 1, wherein the middle section comprises four quadrilateral wall panels and four hexagonal wall panels, with the quadrilateral wall panels and the hexagonal wall panels alternating around the middle section.

7. The stackable container of claim 6, wherein the quadrilateral wall panels are square wall panels.

8. The stackable container of claim 1, wherein the upper section comprises four upper hexagonal wall panels.

9. The stackable container of claim 8, wherein the upper section further comprises four upper shoulders positioned between the four upper hexagonal wall panels.

10. The stackable container of claim 1, wherein the lower section comprises four lower hexagonal wall panels.

11. The stackable container of claim 10, wherein the lower section further comprises four lower shoulders positioned between the four lower hexagonal wall panels.

12. The stackable container of claim 9, wherein the upper shoulders are triangular shaped.

13. The stackable container of claim 11, wherein the lower shoulders are triangular shaped.

14. A method of diagonally stacking a plurality of stackable containers as defined in claim 1 such that an axis of each container is on the diagonal, the method comprising:
positioning a first row of containers in diagonal orientation with one of the upper wall panels of one container contacting one of the lower wall panels of an adjacent container in the first row of containers,
positioning a second row of containers in diagonal orientation on top of the first row of containers with one of the lower wall panels of each container in the second row of containers overlying one of the upper wall panels of each adjacent container in the first row of containers, and
interconnecting the cap of containers in the first row of containers with the recess of diagonally adjacent containers in the second row of containers.
